(19) United States
(12) Patent Application Publication
(10) Pub. No.: US 2012/0033335 A1
(43) Pub. Date: Feb. 9, 2012

(54) ESD Protection Scheme for Integrated Circuit Having Multi-Power Domains

(75) Inventors: Wen-Tai Wang, Zhubei (TW); Fan-yi Jien, Taichung (TW)

(73) Assignee: GLOBAL UNICHIP CORPORATION, Hsinchu (TW)

(21) Appl. No.: 12/849,235

(22) Filed: Aug. 3, 2010

(51) Int. Cl. H02H 9/04

(52) U.S. Cl. 361/56

(57) ABSTRACT

The invention provides systems and methods for ESD protection for an integrated circuit (IC) having multi-power domains. The IC comprises a first device in a first power domain having a first power line and a first ground line and a second device in a second power domain having a second power line and a second ground line. A clamp circuit having a first node and a second node is coupled to the first device and the second device to provide cross-domain protection. Alternatively, two clamp circuits are used to couple with the first device and the second device to provide cross-domain ESD protection.

### FIELD OF THE INVENTION

The present invention relates to integrated circuit design, and more particularly to electrostatic discharge (ESD) protection systems and methods for an integrated circuit having multi-power domains.

### BACKGROUND

Electrostatic discharge (ESD) has been always an issue for integrated circuit (IC) reliability and the issue becomes more of concern with technology scaling and high system integration. The ESD phenomenon may induce transient voltage as high as a few thousand volts at IC pins and cause large transient current that may damage the internal circuit. In order to protect the device from ESD damage, dedicated external devices were used to provide the needed protection. However, in recent years, on-chip ESD protection becomes a common practice in IC design due to the cost and space saving and the convenience. Depending on the intended level of ESD protection, either partial pins or all pins of an IC chip are equipped with ESD protection circuits. Furthermore, there exist several ESD models being widely used in the industry for ESD protection assessment, including Machine Model (MM), Human Body Model (HBM) and Charged Device Model (CDM). There are also several voltage levels associated with each test model to designate the ESD protection capability of a device under test.

In light of the advancement in IC technology, more circuits corresponding to various devices for a system are packed into a single integrated circuit. The IC may contain not only mixed types of circuits, such as analog circuit and digital circuits, but also circuits having multiple power supply voltages. In a conventional ESD protection approach, the design has been focused on the ESD protection within a single device. For example, the ESD protection may be only individually considered for an analog circuit having 1.1V supply, such as a variable gain amplifier circuit within an integrated television receiver chip without addressing the possible ESD damage across different devices within the IC. A typical ESD protection circuit used between the power and ground lines is a clamp circuit that can cause the large ESD current to flow through the clamp circuit and quickly reduce the induced high voltage on the power line. Consequently, the circuits connected between the power and ground lines are protected. In order to provide an ESD current path for the ground lines corresponding to different power domains, the ground lines usually are connected through a diode module wherein a pair of diodes is connected back to back. The diode module may also contain two strings of series-connected diodes and the two strings are connected back to back. The diode module allows the passage of large ESD current while avoid noise coupling between the two coupled devices.

For an IC device having multi-power domains, any interface circuit coupled to circuits in the different power domains may be subject to cross-domain ESD damage. In a technical paper, entitled “ESD Protection Design to Overcome Internal Damage on Interface Circuits of a CMOS IC With Multiple Separated Power Pins,” by Ming-Dou Ker, Chyh-Yih Chang, and Yi-Shu Chang, published in IEEE TRANS. on Components and Packaging Technologies, Vol. 27, No. 3, pp. 445-451, September 2004, a gate-grounded NMOS (or PMOS) is disclosed to improve cross-domain ESD protection. The method will require the gate-grounded NMOS (or PMOS) device added to all interfaces between the two devices having separate power domains. In the US Patent Application Publication, entitled “ESD Protection System for Multi-Power Domain Circuitry,” Publication No. US 2007/0091523 A1, dated Apr. 26, 2007, by Ker-Min Chen, an interface buffer module is disclosed to overcome the ESD problem associated with multi-power domains. The interface buffer module can increase the impedance in the ESD condition to prevent large current from flowing through the interface circuit. Again, the interface buffer module has to be used for all interfaces. Furthermore, the effectiveness of the interface buffer module regarding cross-domain ESD protection is unclear. Therefore, it is desirable to provide effective and reliable protection systems and methods to avoid cross-domain ESD damage.

### BRIEF SUMMARY OF THE INVENTION

An integrated circuit (IC) having on-chip electrostatic discharge (ESD) protection is disclosed. According to one embodiment of the present invention, the IC comprises a first device, a second device, and a protection module. The first device is in a first power domain having a first high power line and a first low power line, and the second device is in a second power domain having a second high power line and a second low power line. The protection module has a first node and a second node, wherein the first node is coupled to the first high power line and the second node is coupled to the second low power line to provide ESD protection between the first device and the second device. In an IC according to one embodiment of the present invention, the first device is a digital device and the second device is an analog device. Yet in an IC according to another embodiment of the present invention, the first device is an analog device and the second device is a digital device. According to the present invention, the first node of the protection module can be alternatively connected to a pad or an internal bus of the first high power line. Similarly, the second node of the protection module can be alternatively connected to a pad or an internal bus of the second low power line.

According to another embodiment of the present invention, the IC comprises a first device, a second device, a first protection module and a second protection module. The first device is in a first power domain having a first high power line and a first low power line, and the second device is in a second power domain having a second high power line and a second low power line. The first protection module has a first node and a second node, wherein the first node is coupled to the first high power line and the second node is coupled to the second low power line to provide ESD protection between the first device and the second device. The second protection module has a third node and a fourth node, wherein the third node is coupled to the second high power line and the fourth node is coupled to the first low power line to provide ESD protection between the first device and the second device.

According to another embodiment of the present invention, a method is disclosed for providing electrostatic discharge (ESD) protection to a first device in a first power domain having a first high power line and a first low power line and a second device in a second power domain having a second high power line and a second low power line. The method comprises steps of (a) providing a first protection module having a first node and a second node, (b) coupling the first node of the first protection module to the first high power line of the first device, and (c) coupling the second node of the first protection module to the second low power line of the second device. In an alternative ESD protection method, the method includes further steps of (d) providing a second protection module having a third node and a fourth node, (e) coupling the third node of the second protection module to the second high power line of the second device, and (f) coupling the fourth node of the second protection module to the first low power line of the first device.

### BRIEF DESCRIPTION OF THE DRAWINGS

FIG. 1 illustrates an ESD protection arrangement where a clamp circuit is used and the VSS for the I/O circuit is used as a common local ESD ground bus.

FIG. 2 illustrates an ESD protection arrangement where a clamp circuit is used and the VSS for the core circuit is used as a common local ESD ground bus.

FIG. 3 illustrates an ESD protection arrangement where a clamp circuit is used and the joined VSS for the core circuit and the I/O circuit is used as a common local ESD ground bus.

FIG. 4 illustrates a scenario of ESD failure where interface circuits are coupled to two devices without cross-domain ESD protection and the points of ESD failure are indicated.

FIG. 5 illustrates noise coupling in a device having multiple power domains and conventional ESD protection without cross-domain ESD protection.

FIG. 6 illustrates possible routes of ESD failure where an interface circuit is coupled between two devices without cross-domain ESD protection.

FIG. 7 illustrates an embodiment of the present invention where a pair of protection circuits is coupled between two devices to provide cross-domain ESD protection.

FIG. 8 illustrates an embodiment of the present invention where a protection circuit is coupled between two devices to provide cross-domain ESD protection.

FIGS. 9A-F illustrate various configurations of connecting a protection circuit to the high power line and the low power line.

FIG. 10 illustrates an example of integrated circuit containing an embodiment of the present invention where a protection circuit is coupled between a digital device and an analog device to provide cross-domain ESD protection.

### DETAILED DESCRIPTION OF THE INVENTION

In order to protect a device from possible ESD damage, ESD protection circuit is often used. For integrated circuit application, it has been a technology trend to incorporate on-chip ESD protection circuits to reduce system cost as well to system space. In a typical ESD protection design, a type of protection circuit is included between the high power supply line VDD and the low power supply line, often also called ground line VSS. The high power supply line may also be called high power line or simply VDD for short. The low power supply line may also be called low power line or ground line for short. To prevent the possible damage to the circuits attached between the VDD and VSS caused by the high transient voltage associated with the ESD, a fast-response protection circuit, typically a clamp circuit is often used as the protection element. The clamp circuit is capable of quickly reducing the high transient voltage, which could be as high as several hundred or several thousand volts, across the VDD and VSS to a much lower voltage. The implementation of an ESD protection element such as the clamp circuit is well known to those skilled in the field and the details of the protection element are not further described herein. In the IC industry, there exist some ESD models and standard test procedures to measure the ESD protection capabilities of a device under test. There are three ESD models often used to set up the test environment: Machine Model (MM), Human Body Model (HBM) and Charged Device Model (CDM). There are several test voltage levels used as designation of ESD protection capability. For example, a device is qualified for HBM 2 kV is referring to a device that can sustain the ESD test using the HBM up to 2,000 volts. It is very desirable to provide high ESD protection capability to a device so that the device can survive in various hostile environments during packaging, shipping, assembly and usage.

In light of the advancement in semiconductor technology, more circuits are integrated onto the same substrate or same package. Furthermore, the complexity of integrated circuit has also grown rapidly so that an integrated circuit may contain many difference devices on the same die. For example, a highly integrated television receiver chip may contain analog front end (AFE) circuit which is essentially all high-frequency (RF and/or IF) analog circuits, mixer, analog-to-digital converter, digital signal processor, video DAC, audio DAC, various analog and digital peripheral circuits, clock generation circuit, and etc. These devices may have different power requirement such as 2.5V and 1.2 V. Furthermore, to reduce noise coupling, the digital power domain usually is isolated from the analog power domain. While ESD protection may be incorporated in individual devices, it does not necessarily provide adequate ESD protection across different devices in different power domains on the same integrated circuit.

FIG. 1 illustrates an exemplary device 100 having a common local ESD ground bus VSS_IO1 130 and ESD protection circuits, 110a and 120a-c. The clamp circuit 110a is placed between the high core power supply line VDD_core1 and the local ESD ground bus VSS_IO1 130. In a typical application, the low power supply VSS may be coupled to the substrate of the semiconductor device and the substrate is connected to the ground of a power supply. Therefore, sometime the low power supply line is also referred to as ground line for convenience. Also shown in FIG. 1 are diode pairs, 120a-c, connected back to back to provide conductive paths for large surge current while avoid noise coupling among ground lines of different power domains. For example, a diode pair 120b is placed between the low power supply line VSS_core1 for the core circuit and the low power supply line VSS_IO1 130 for the I/O circuit. Both diode pairs 120a and 120c are used to connect the ESD ground bus VSS_IO1 130 to low power supply lines of other power domains not shown in FIG. 1. The example in FIG. 1 illustrates the use of the VSS for the I/O circuit as the common ground bus. While a diode pair is shown in FIG. 1 for connecting ground lines with reduced noise coupling, a diode module may be used, where one or more series-connected diodes on each side is used instead of a single diode.

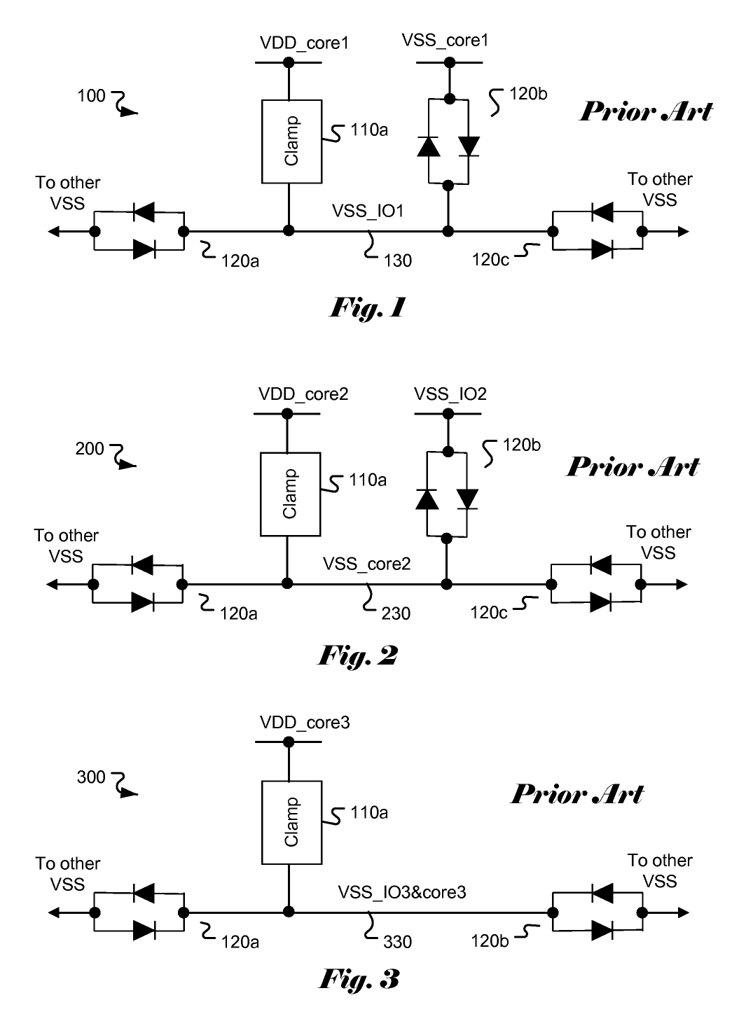

FIG. 2 illustrates another exemplary ESD protection arrangement 200 having a common local ESD ground bus VSS_core2 230 and ESD protection circuits, 110a and 120a-c. Similar to FIG. 1, the clamp circuit 110a is placed between the high core power supply line VDD_core2 and the local ESD ground bus VSS_core2 230. Unlike the device in FIG. 1 where the I/O ground line is used as the ground bus, the device in FIG. 2 uses the core ground line VSS_core2 as the ground bus. FIG. 3 illustrates yet another exemplary ESD protection arrangement 300, where the joined VSS for I/O the circuit and VSS for the core circuit, VSS_IO3&core3 330, is used as a ground bus. A clamp circuit 110a is placed between the high core power supply line VDD_core3 and the local ESD ground bus VSS_IO3&core3 330.

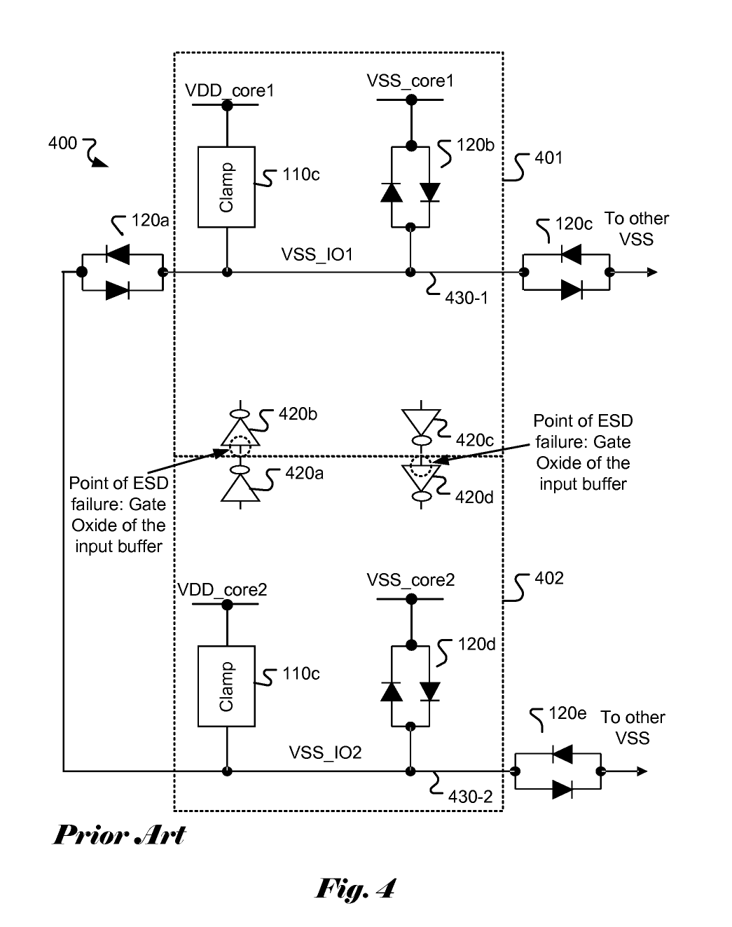

FIG. 4 illustrates a scenario of ESD failure where interface circuits are coupled with two devices without cross-domain ESD protection. The device 400 comprises a first device 401 in the upper part of FIG. 4 and a second device 402 in the lower part of FIG. 4. The first device 401 has a ground bus 430-1 based on the ground line for the I/O circuit VSS_IO1 while the second device 402 has a ground bus 430-2 based on the ground line for the I/O circuit VSS_IO2. As is practiced in a conventional approach, the ground buses for the two devices are connected through a diode pair 120a to provide ESD current path across devices while reducing noise coupling. The diode pairs 120c and 120e are used to further connect the ground buses to additional ground buses. However, this arrangement is not sufficient to provide the needed ESD protection across the two devices. Interface circuits 420a-d, typically buffers consisting of inverters, are illustrated as an example to demonstrate possible ESD damage routes across the two devices 401 and 402. Inverters 420a and 420b serve as buffers for signal flowing from device 402 to device 401. Similarly, inverters 420c and 420d serve as buffers for signal flowing from device 401 to device 402. There are several possible ESD damage paths between the two devices. For example, a high ESD voltage induced on the VDD_core2 may flow through inverters 420a and 420b to the VSS_IO1, and cause damage to the gate-oxide of the input buffer 420b for the first device 401. Similarly, a high ESD voltage induced on the VDD_core1 may flow through inverters 420c and 420d to VSS_IO2, and cause damage to the gate-oxide of the input buffer 420d for the second device 402. There is also a potential ESD damage route between the VDD_core1 and VDD_core2 which may cause damage to the gate-oxide of inverter 420b or 420d. Therefore, a conventional ESD protection scheme for a multiple power-domain device does not provide sufficient protection for interface circuits coupled to different power domains.

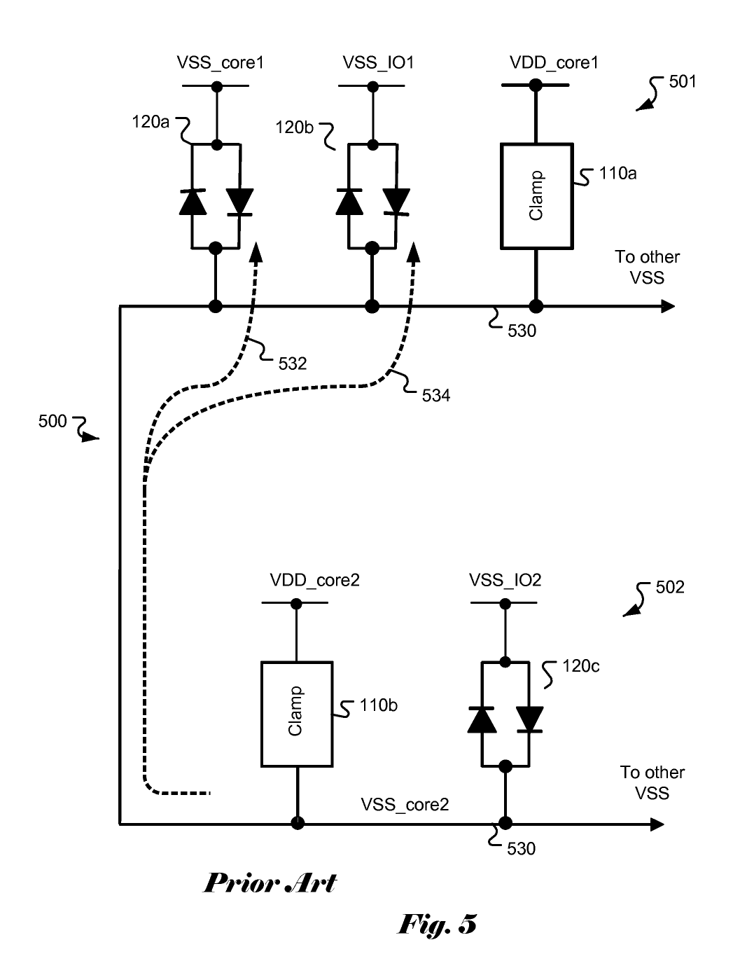

FIG. 5 illustrates noise coupling in a device having multiple power domains and conventional ESD protection without cross-domain ESD protection. In this example, the VSS_core2 is used as the common ground bus 530 for the whole device 500. The first device 501 in the upper part of FIG. 5 represents the ESD protection scheme for an analog device while the second device 502 in the lower part of FIG. 5 represents the ESD protection scheme for a digital device. As is well known in the field of electronic circuits, an analog circuit usually is more prone to noise than a digital circuit. When the digital VSS_core2 is used as the common ESD ground bus, the digital noise in the digital supply line VSS_core2 will be coupled to the analog supply lines VSS_core1 and VSS_IO1 through the paths 532 and 534.

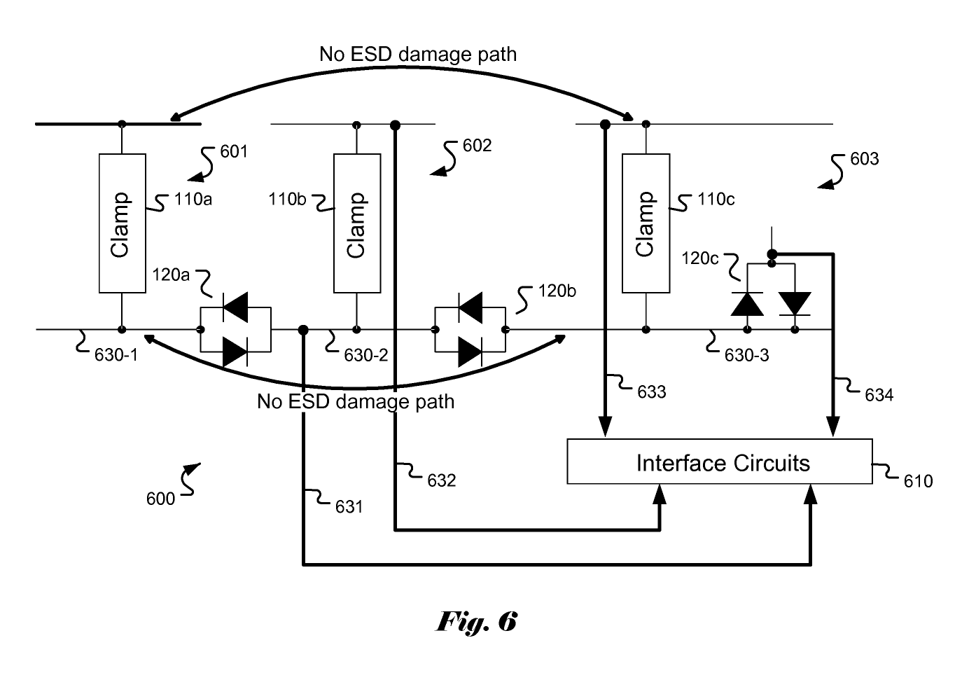

FIG. 6 illustrates a scenario of integrated circuits having three power domains corresponding to devices 601, 602 and 603. There exists an interface circuit 610 between devices 602 and 603 and there is no interface between devices 601 and 603. As described in the discussion associated with FIG. 5, there are several possible ESD damage paths between devices 602 and 603 in a conventional ESD protection arrangement. The potential ESD damage paths 632a-b and 634a-b are shown in FIG. 6. The ground lines 630-1, 630-2 and 630-3 are connected together through diode pairs 120a and 120b. In the case that no interface circuit exists between the device 601 and device 603, there is no ESD damage path exists between the two devices. Therefore, there is no need to protect the cross-domain ESD between devices 601 and 603 if there is no interface circuit exists between the two associated power domains.

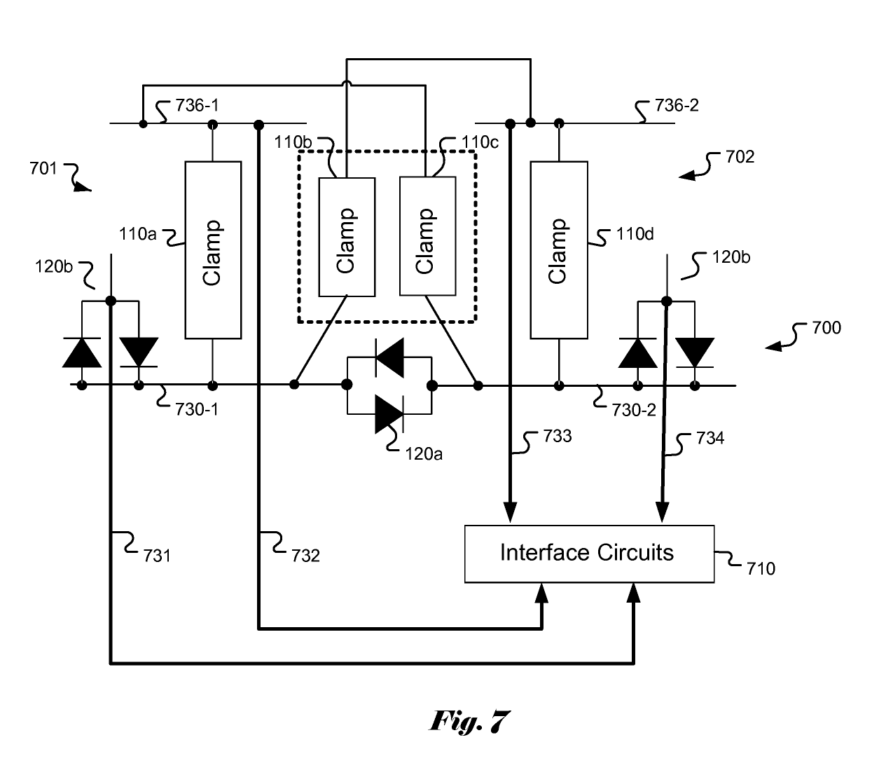

FIG. 7 illustrates one embodiment of the present invention where a pair of clamp circuits, 110b and 110c, is coupled with the two devices in separate power domains to provide cross-domain ESD protection. The integrated circuit 700 of FIG. 7 comprises a device 701 having a first power domain and a second device 702 having a second power domain, where the two devices are coupled to an interface circuit 710. The first device uses a clamp circuit 110a between the power supply lines 736-1 and 730-1 and the second device uses a clamp circuit 110d between the power supply lines 736-2 and 730-2 to provide ESD protection within the device. The possible ESD damage paths are indicated as 732/733 and 731/734. To provide cross-domain ESD protection, a pair of clamp circuits 110b and 110c is coupled with the two devices. As shown in FIG. 7, the clamp circuit 110b is coupled to the high power line 736-2 of device 702 and to the low power line 730-1 of the device 701. An ESD voltage induced on the high power line 736-2 of device 702 will be clamped by the clamp circuit 110b so that the current surge will flow through the clamp circuit 110b to the ground bus 730-1 instead of the interface circuit 710. Similarly, an ESD voltage induced on the high power line 736-1 of device 701 will be clamped by the clamp circuit 110c so that the current surge will flow through the clamp circuit 110c to the ground bus 730-2 instead of the interface circuit 710. Consequently, the cross power domain ESD protection is accomplished.

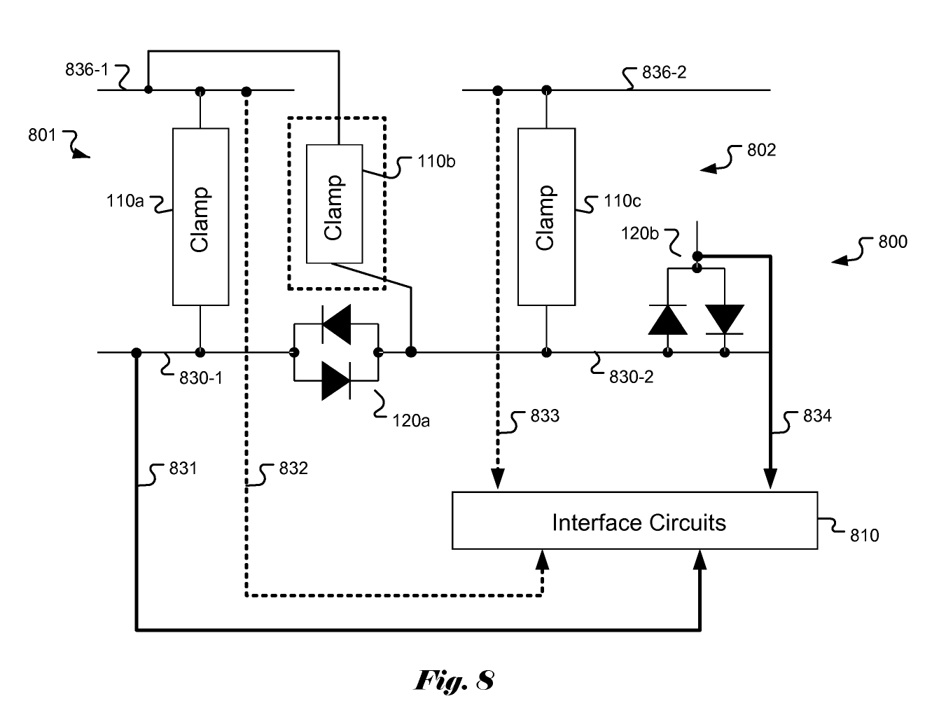

FIG. 8 illustrates another embodiment of the present invention where a clamp circuit 110b is coupled between the two devices to provide cross-domain ESD protection. The integrated circuit 800 of FIG. 8 comprises a device 801 having a first power domain and a second device 802 having a second power domain, where the two devices are coupled to an interface circuit 810. The first device uses a clamp circuit 110a between the power supply lines 836-1 and 830-1 and the second device uses a clamp circuit 110c between the power supply lines 836-2 and 830-2 to provide ESD protection within the device. The possible ESD damage paths are indicated as 832/833 and 831/834. To provide cross-domain ESD protection, the clamp circuit 110b is coupled with the two devices as shown in FIG. 8. An ESD voltage induced on the high power line 836-1 of device 801 will be clamped by the clamp circuit 110b so that the current surge will flow through the clamp circuit 110b to the ground bus 830-2 instead of the interface circuit 810. Similarly, if an ESD voltage is induced on the high power line 836-2, the current will go to the high power line 836-1 through clamp circuits 110c and 110b or go to the low power line 830-1 through clamp circuit 110c and ESD protection circuit 120a. Consequently, the cross power domain ESD protection is accomplished.

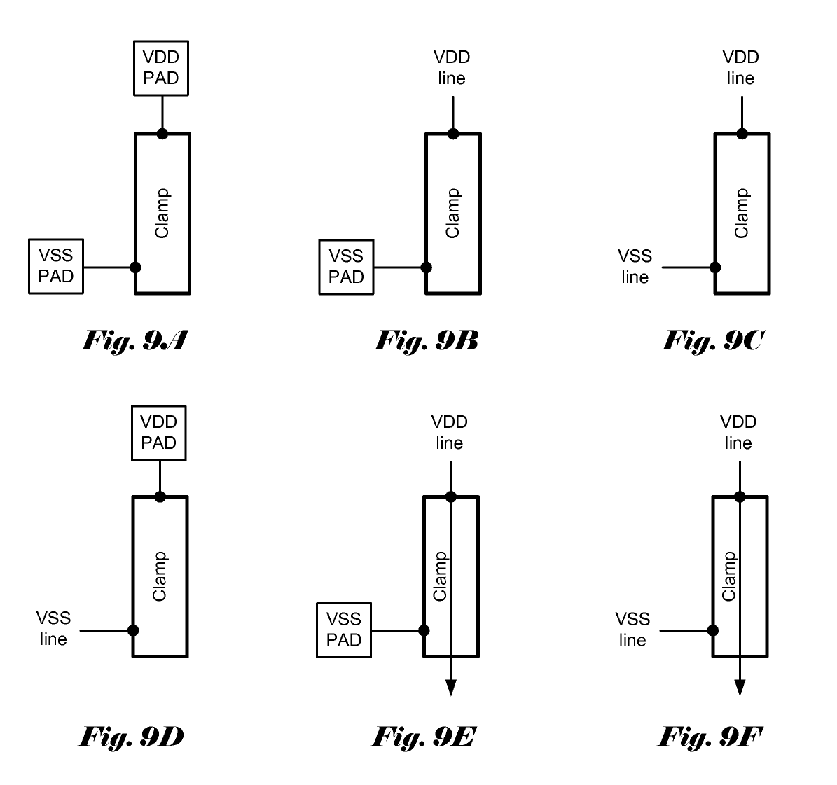

The clamp circuit can be coupled to the power lines of a device in several means as shown in FIG. 9. In typical IC layout, the clamp circuit for ESD protection can be connected to a pad of a high power line, i.e., the VDD PAD and to a pad of a low power line, i.e., the VSS PAD as shown in FIG. 9A. Nevertheless, the clamp circuit may also be connected to internal power lines to achieve the purpose of cross power domain ESD protection. For example, FIG. 9B shows a clamp circuit connected between an internal VDD line and a VSS PAD, FIG. 9C shows a clamp circuit connected between an internal VDD line and an internal VSS line, and FIG. 9D shows a clamp circuit connected to a VDD PAD and an internal VSS line. In this case, part of core areas may be blocked by other circuits and there are no VDD or VSS pads nearby. For IC layout, a technique call “feed through” is often used as a means to allow traces for power/ground lines to go through a large circuit block. Otherwise, the traces would have to be routed around the large circuit block which will unnecessarily increase the routing length. This will degrade signal quality in the particular area. When a high power supply line is fed through a circuit block, such as the clamp circuit, the clamp circuit may be coupled to the feed through power line for ESD protection purpose. FIGS. 9E and 9F shows clamp circuits coupled to a feed through power/ground line.

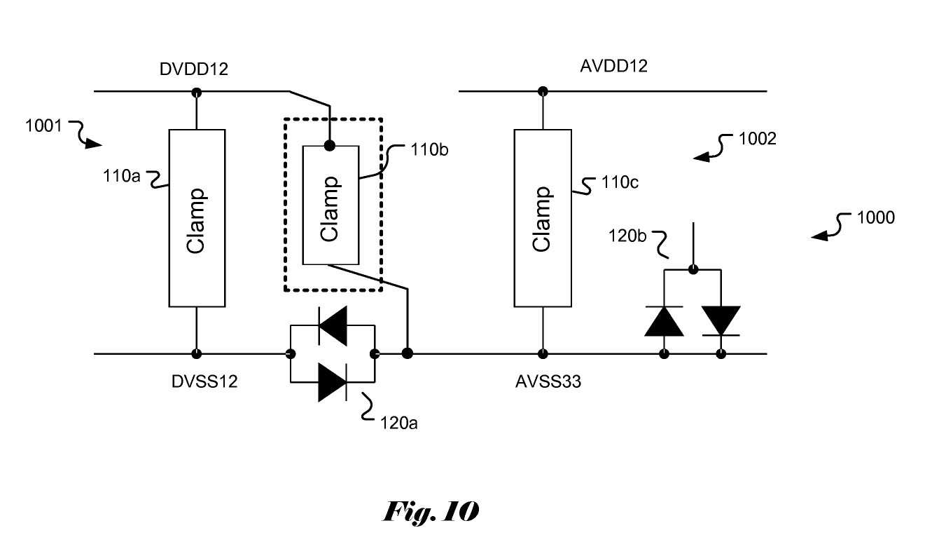

FIG. 10 illustrates an example of integrated circuit 1000 containing an embodiment of the present invention where a protection circuit 110b is coupled between a digital device 1001 and an analog device 1002 to provide cross-domain ESD protection. The digital device includes a clamp 110a coupled between the supply lines DVDD12 and DVSS12 to provide ESD protection for the digital circuit. The analog device includes a clamp circuit 110c coupled between power lines AVDD12 and AVSS12 to provide ESD protection for the analog circuit. The cross-domain ESD protection arrangement shown in FIG. 10 has been implemented in a mixed signal television chip using 0.13 μm technology. The television chip has been tested for cross-domain ESD protection to sustain HBM at 2 kV, MM at 200V and CDM at 1 kV.

The above drawings, examples, and illustrations provide many different embodiments or embodiments for implementing different features of the present invention. Specific embodiments of components and processes are described to help explain and clarify the invention. These are not intended to limit the invention from that described in the claims. Furthermore, while the invention is illustrated and described herein as embodied in one or more specific examples, it is not intended to be limited to the details shown, since various modifications and structural changes may be practiced therein by those skilled in the art without departing from the spirit of the invention and within the scope and range of equivalents of the claims. Therefore, the appended claims should be construed broadly and in a manner consistent with the scope of the invention, as set forth in the following claims.

1. An integrated circuit having on-chip electrostatic discharge (ESD) protection, comprising:
a first device in a first power domain having a first high power line and a first low power line;
a second device in a second power domain having a second high power line and a second low power line; and
a clamp circuit having a first node and a second node, wherein the first node is coupled to the first high power line and the second node is coupled to the second low power line to provide ESD protection between the first device and the second device.

2. The integrated circuit of claim 1, wherein the first device is a digital device and the second device is an analog device.

3. The integrated circuit of claim 1, wherein the first device is an analog device and the second device is a digital device.

4. The integrated circuit of claim 1, wherein the first power domain uses a first voltage and the second power domain uses a second voltage, wherein the first voltage is different from the second voltage.

5. The integrated circuit of claim 1, wherein the first node of the clamp circuit is connected to a pad of the first high power line.

6. The integrated circuit of claim 1, wherein the first node of the clamp circuit is connected to an internal bus of the first high power line.

7. The integrated circuit of claim 1, wherein the second node of the clamp circuit is connected to a pad of the second low power line.

8. The integrated circuit of claim 1, wherein the second node of the clamp circuit is connected to an internal bus of the second low power line.

9. The integrated circuit of claim 1, wherein the first high power line is a feed through high power line.

10. The integrated circuit of claim 1, wherein the second low power line is a feed through low power line.

11. The integrated circuit of claim 1, wherein the first low power line is coupled with the second low power line through a bi-directional conductive device to reduce noise coupling between the first low power line and the second low power line.

12. The integrated circuit of claim 11, wherein the bi-directional conductive device comprises a diode module, the diode module comprises two diode strings connected back to back, and each of two diode strings comprises at least one series-connected diode.

13. An integrated circuit having on-chip electrostatic discharge (ESD) protection, comprising:
a first device in a first power domain having a first high power line and a first low power line;
a second device in a second power domain having a second high power line and a second low power line;
a first clamp circuit having a first node and a second node, wherein the first node is coupled to the first high power line and the second node is coupled to the second low power line; and
a second clamp circuit having a third node and a fourth node, wherein the third node is coupled to the second high power line and the fourth node is coupled to the first low power line;
wherein the first clamp circuit and the second clamp circuit provide ESD protection between the first device and the second device.

14. The integrated circuit of claim 13, wherein the first device is a digital device and the second device is an analog device.

15. The integrated circuit of claim 13, wherein the first device is an analog device and the second device is a digital device.

16. The integrated circuit of claim 13, wherein the first power domain uses a first voltage and the second power domain uses a second voltage, wherein the first voltage is different from the second voltage.

17. The integrated circuit of claim 13, wherein the first node of the clamp circuit is connected to a pad of the first high power line.

18. The integrated circuit of claim 13, wherein the first node of the clamp circuit is connected to an internal bus of the first high power line.

19. The integrated circuit of claim 13, wherein the second node of the clamp circuit is connected to a pad of the second low power line.

20. The integrated circuit of claim 13, wherein the second node of the clamp circuit is connected to an internal bus of the second low power line.

21. The integrated circuit of claim 13, wherein the first high power line is a feed through high power line.

22. The integrated circuit of claim 13, wherein the second low power line is a feed through low power line.

23. A method for providing electrostatic discharge (ESD) protection to a first device in a first power domain having a first high power line and a first low power line and a second device in a second power domain having a second high power line and a second low power line, the method comprising:
providing a first clamp circuit having a first node and a second node;
coupling the first node of the first clamp circuit to the first high power line of the first device; and
coupling the second node of the first clamp circuit to the second low power line of the second device.

24. The method of claim 23, further comprising:
providing a second clamp circuit having a third node and a fourth node;
coupling the third node of the second clamp circuit to the second high power line of the second device; and
coupling the fourth node of the second clamp circuit to the first low power line of the first device.
